(19) United States
(12) Patent Application Publication
(10) Pub. No.: US 2025/0339794 A1
(43) Pub. Date: Nov. 6, 2025

(54) PRODUCT FOR MINE TAILINGS

(71) Applicant: Active Minerals International, LLC, Sparks, MD (US)

(72) Inventors: Bo WANG, Houston, TX (US); Nestor Alirio CRUZ, Houston, TX (US); Tyler Chanting PULLIG, Houston, TX (US); Dennis PARKER, Victor, ID (US)

(73) Assignee: Active Minerals International, LLC, Sparks, MD (US)

(21) Appl. No.: 18/655,744

(22) Filed: May 6, 2024

(51) Int. Cl. B01D 21/01; B01J 20/12; B01J 20/14; B01J 20/26

(52) U.S. Cl. CPC B01D 21/01; B01J 20/12; B01J 20/14; B01J 20/261

(57) ABSTRACT

A product and method of producing a product that may comprise diatomaceous earth, clay and dispersant. The clay may comprise (a) attapulgite or (b) sepiolite or (c) attapulgite and sepiolite. A portion of the clay and a portion of the diatomaceous earth is agglomerated to form a plurality of composite particles, wherein the composite particle is at least partially surface treated with the dispersant. The product may have a particle size distribution having a d₅₀ of 5-40 microns and a d₁₀ of 1-15 microns. The product may have a median pore diameter of 2-10 microns, a pore volume of 1-4 mL/g and a bulk density of 50-300 kg/m³.

### TECHNICAL FIELD

The present disclosure generally relates to products comprising clay that are used to improve filtration pressure, flowability and pump efficiency (also referred to as pumping efficiency or pumpability) of slurries found in mineral processing industries, such as mine tailing slurries.

### BACKGROUND

Tailings are a by-product of mining ore that contains a mineral such as copper, gold, silver, iron, lead, zinc, uranium, rare earth, coal or the like. After the mineral is extracted from the ore material, the resultant waste stream, termed a “tailing” slurry, comprises finely ground mineral solids and water. The tailing slurry is typically pumped to a tailings facility for further processing to separate water from the tailings slurry. Often the tailing slurry is pumped into filters to produce a filter cake product that can be transported and stored or disposed of.

U.S. Pat. No. 9,943,860 (the '860 patent) describes a synthetic material having hydrophobic molecules. When the mineral particles of interest in the mine tailings are combined with collector molecules, the mineral particles of interest may also become hydrophobic and become attracted to a hydrophobic collection area or surface. While beneficial for collecting mineral particles in mine tailings, a better and more cost effective solution is desired for improving filtration of mine tailing slurries.

### SUMMARY OF THE DISCLOSURE

In one aspect of the present disclosure, a product is disclosed. The product may comprise 9 wt. %-90 wt. % diatomaceous earth, wherein the diatomaceous earth includes flux-calcined diatomaceous earth or calcined diatomaceous earth; 9 wt. %-90 wt. % clay, the clay comprising (a) attapulgite or (b) sepiolite or (c) attapulgite and sepiolite; and 1 wt. %-5 wt. % dispersant, wherein a portion the clay and a portion of the diatomaceous earth is agglomerated to form a plurality of composite particles, each composite particle in the plurality comprised of one or more clay particles attached to an outer surface of a diatomite particle or disposed inside a pore of the diatomite particle, wherein the composite particle is at least partially surface treated with the dispersant. the product may have a particle size distribution having a d₅₀ of 5-40 microns and a d₁₀ of 1-15 microns. The product may have a median pore diameter of 2-10 microns, a pore volume of 1-4 mL/g and a bulk density of 50-300 kg/m³.

In an embodiment, the product may be adapted to reduce a filtration pressure of a mine tailing slurry after a dispersal of a dosage amount of the product in the mine tailing slurry, wherein prior to the dispersal of the dosage amount of the product, the mine tailing slurry comprises solids and a liquid, wherein the solids comprises mineral solid particulates. In a refinement, the product may be adapted to reduce the filtration pressure by 0.01% to 20%. In another refinement, the product may be adapted to reduce the filtration pressure of the mine tailing slurry by 0.01%-30% more than a same amount of attapulgite dispersed in the mine tailing slurry. In an embodiment, the mineral solid particulates may include metal particulates. In an embodiment, the mineral solid particulates may include coal particulates.

In any one of the embodiments, the product may be adapted to: (a) provide 0.01% to 15% decrease in viscosity of the mine tailing slurry after dispersal of the dosage amount of the product in the mine tailing slurry; and/or (b) increase a pump efficiency and/or a flow rate of the mine tailing slurry after a dispersal of the dosage amount of the product in the mine tailing slurry.

In any one of the embodiments above, the dosage amount of the product added to the mine tailing slurry may be 0.01 wt. %-3 wt. % of a dry weight of the solids of the mine tailing slurry.

In any one of the embodiments above, the product may have a particle size distribution d₉₀ of 30-120 microns.

In any one of the embodiments above, the dispersant may comprise sodium polyacrylate, tetrasodium pyrophosphate (TSPP), sodium silicate, sodium tripolyphosphate (STPP), or sodium hexametaphosphate (SHMP).

In another aspect of the disclosure, a method of producing a product for reducing filtration pressure and viscosity in a mine tailing slurry. The method may comprise: selecting a diatomaceous earth as a first feed material; selecting a clay as second feed material, wherein the clay comprises (a) attapulgite or (b) sepiolite or (c) attapulgite and sepiolite; mixing a dispersant solution, the clay and the diatomaceous earth to form a mixture in which a portion the clay and a portion of the diatomaceous earth is agglomerated to form a plurality of composite particles, each composite particle in the plurality comprised of a clay particle attached to an outer surface of a diatomite particle or disposed inside a pore of the diatomite particle; and drying the mixture. The dispersant solution may include a dispersant, wherein the composite particle is at least partially surface treated with the dispersant solution. The product may have a particle size distribution having a d₁₀ of 1-15 microns. The product may have a particle size distribution having a d₅₀ of 5-40 microns. The product may have a median pore diameter of 2-10 microns, a pore volume of 1-4 mL/g and a bulk density of 50-300 kg/m³. The product is adapted to reduce a filtration pressure of a mine tailing slurry after a dispersal of the product in the mine tailing slurry and to provide 0.01% to 15% decrease in viscosity of the mine tailing slurry after dispersal of the product in the mine tailing slurry. Prior to the dispersal of the product, the mine tailing slurry comprises mineral solid particulates and a liquid.

In an embodiment, a weight percentage of components of the product may include 9 wt. %-90 wt. % clay.

In any one of the embodiments above, the diatomaceous earth may include or may be (a) calcined diatomaceous earth or (b) flux-calcined diatomaceous earth or (c) calcined diatomaceous earth and flux-calcined diatomaceous earth.

In any one of the embodiments above, the product may be adapted to reduce the filtration pressure of the mine tailing slurry by 0.01% to 20%.

In any one of the embodiments above, the product may have a surface area of 1-280 m²/g.

In any one of the embodiments above, the product may have a particle size distribution having a d₉₀ of 30-120 microns.

In any one of the embodiments above, the product may be adapted to increase a pump efficiency and/or a flow rate of the mine tailing slurry after a dispersal of the product in the mine tailing slurry and as compared the mine tailing slurry when free of the product.

In any one of the embodiments above, the dispersant may be 1 wt. %-5 wt. % of the product, wherein the dispersant may include sodium polyacrylate, tetrasodium pyrophosphate (TSPP), sodium silicate, sodium tripolyphosphate (STPP), or sodium hexametaphosphate (SHMP).

In yet another aspect of the disclosure a product is disclosed. The product may comprise composite particulates surface treated with a dispersant. The composite particulates may comprise: diatomaceous earth, and clay. The clay may comprise (a) attapulgite or (b) sepiolite or (c) attapulgite and sepiolite. The product may have a particle size distribution having a d₅₀ of 5-40 microns and d₁₀ of 1-15 microns. The product may have a median pore diameter of 2-10 microns, a pore volume of 1-4 mL/g and a bulk density of 50-300 kg/m³. The product may further have a surface area of 1-280 m²/g. The product may be adapted to reduce by 0.01% to 20% a filtration pressure of a mine tailing slurry after a dispersal of a dosage amount of the product in the mine tailing slurry. The product may further be adapted to reduce by 0.01% to 15% a viscosity of the mine tailing slurry after the dispersal of the dosage amount of the product in the mine tailing slurry. Prior to the dispersal of the dosage amount of the product in the mine tailing slurry, the mine tailing slurry comprises solids and liquid, wherein the solids comprises mineral solid particulates.

In an embodiment, the dosage amount may be 0.01 wt. %-3 wt. % of a dry weight of the solids of the mine tailing slurry.

In any one of the embodiments above, the product may be adapted to increase a pump efficiency and/or a flow rate of the mine tailing slurry after dispersal of the dosage amount of the product in the mine tailing slurry.

In any one of the embodiments above, the dispersant may include sodium polyacrylate, tetrasodium pyrophosphate (TSPP), sodium silicate, sodium tripolyphosphate (STPP), or sodium hexametaphosphate (SHMP).

In any one of the embodiments above, the diatomaceous earth may be flux-calcined or straight calcined.

In any one of the embodiments above, the product may be adapted to reduce the filtration pressure of the mine tailing slurry by 0.01%-30% more than a same amount of attapulgite dispersed in the mine tailing slurry.

In any one of the embodiments above, the mineral solid particulates may include metal particulates. In a refinement, the metal particulates may include copper, gold, silver, iron, lead, zinc, uranium, nickel or rare earth elements. In an embodiment, the mineral solid particulates may include coal particulates.

### BRIEF DESCRIPTION OF THE DRAWINGS

FIG. 1 is a scanning electron microscope (SEM) image of Example 7 at a magnification of ×7000 illustrating attapulgite particles disposed inside the pores of a diatomite particle;

FIG. 2 is a SEM image of Example 7 at a magnification of ×35,000 illustrating attapulgite particles attached to the surface of diatomite particle and inside the pores;

FIG. 3 is a SEM image of Example 9 at a magnification of ×3,500 illustrating sepiolite particles attached to the surface of a diatomite particle;

FIG. 4 is a SEM image of Example 9 at a magnification of ×30,000 illustrating sepiolite particles attached to the surface of a diatomite particle and inside the pores;

FIG. 5 is a graph illustrating the pressure of the respective copper mine tailing slurries to which a 0.03 wt. % dosage of Acti-Gel®, Min-U-Gel® 400, or Example 1 has been added as compared to the control slurry, as measured adjacent to the filter over approximately the first two of minutes of filtration;

FIG. 6 is a graph illustrating the pressure of respective copper mine tailing slurries to which a 0.03 wt. % dosage of Examples 3, 5 or 7 has been added as compared to the control slurry, as measured adjacent to the filter over approximately the first two minutes of filtration;

FIG. 7 is a graph illustrating the impact of diatomaceous earth content in the composition on the copper mine tailing filtration pressure measured at two minutes filtration time;

FIG. 8 a comparison of mine tailing filtration pressure of the respective copper mine tailing slurries to which a 0.03 wt. % dosage of Acti-Gel, Min-U-Gel 400, or Examples 1, 3, 5 or 7 has been added, as measured at two minutes filtration time;

FIG. 9 illustrates a graph of pressure versus tailing filtration time for rare earth mine tailing slurries to which a 0.03 wt. % dosage of Examples 8 or 9 has been added;

FIG. 10 is a graph illustrating the percentage decrease in viscosity at shear rate 10 s⁻¹ of rare earth mine tailing slurries comprising one of Examples 1-9, or commercially available Acti-Gel, or Min-U-Gel 400, as compared to the viscosity of the control sample of the rare earth mine tailing slurry; and

FIG. 11 is a graph illustrating the percentage decrease in viscosity at shear rate 50 s⁻¹ of rare earth mine tailing slurries comprising one of Examples 1-9, or commercially available Acti-Gel, or Min-U-Gel 400, as compared to the control sample of the rare earth mine tailing slurry.

### DETAILED DESCRIPTION

This disclosure relates to a product for improving the filtration pressure and viscosity in mine tailing slurries associated with mineral processing. The products disclosed herein also improve the flowability and pump efficiency/pumpability of such mine tailing slurries. The novel products disclosed herein may comprise composite particles surface treated, at least partially, with a dispersant. The composite particles may comprise or may be clay and diatomaceous earth. The clay may comprise, or may be: (a) attapulgite, or (b) sepiolite, or (c) attapulgite and sepiolite. In an embodiment the diatomaceous earth may comprise or may be: (a) flux-calcined diatomaceous earth, or (b) straight calcined diatomaceous earth, or (c) flux-calcined diatomaceous earth and straight calcined diatomaceous earth.

In some embodiments, the products disclosed herein may comprise or be: about 9 wt. % to about 90 wt. % attapulgite; about 90 wt. % to about 9 wt. % flux-calcined diatomaceous earth; and about 1 wt. % to about 5 wt. % dispersant, wherein at least a portion of the attapulgite and a portion of the flux-calcined diatomaceous earth are in the form of composite particles at least partially surface treated with the dispersant.

In some embodiments, the products disclosed herein may comprise or be: about 9 wt. % to about 90 wt. % sepiolite; about 90 wt. % to about 9 wt. % flux-calcined diatomaceous earth; and about 1 wt. % to about 5 wt. % dispersant, wherein at least a portion of the sepiolite and a portion of the flux-calcined diatomaceous earth are in the form of composite particles at least partially surface treated with the dispersant.

In some embodiments, the products disclosed herein may comprise or be: about 9 wt. % to about 90 wt. % in aggregate (a) attapulgite and (b) sepiolite; about 90 wt. % to about 9 wt. % flux-calcined diatomaceous earth; and about 1 wt. % to about 5 wt. % dispersant, wherein at least a portion of the attapulgite and a portion of the sepiolite and a portion of the flux-calcined diatomaceous earth are in the form of composite particles at least partially surface treated with the dispersant.

In some embodiments, the products disclosed herein may comprise or be: about 9 wt. % to about 90 wt. % attapulgite; about 90 wt. % to about 9 wt. % straight calcined diatomaceous earth; and about 1 wt. % to about 5 wt. % dispersant, wherein at least a portion of the attapulgite and a portion of the straight calcined diatomaceous earth are in the form of composite particles at least partially surface treated with the dispersant.

In some embodiments, the products disclosed herein may comprise or be: about 9 wt. % to about 90 wt. % sepiolite; about 90 wt. % to about 9 wt. % straight calcined diatomaceous earth; and about 1 wt. % to about 5 wt. % dispersant, wherein at least a portion of the sepiolite and a portion of the straight calcined diatomaceous earth are in the form of composite particles at least partially surface treated with the dispersant.

In some embodiments, the products disclosed herein may comprise or be: about 9 wt. % to about 90 wt. % in aggregate (a) attapulgite and (b) sepiolite; about 90 wt. % to about 9 wt. % straight calcined diatomaceous earth; and about 1 wt. % to about 5 wt. % dispersant, wherein at least a portion of the attapulgite and a portion of the sepiolite and a portion of the straight calcined diatomaceous earth are in the form of composite particles at least partially surface treated with the dispersant.

In some embodiments, the products disclosed herein may comprise or be: about 9 wt. % to about 90 wt. % attapulgite; about 90 wt. % to about 9 wt. % in aggregate: (a) straight calcined diatomaceous earth and (b) flux-calcined diatomaceous earth; and about 1 wt. % to about 5 wt. % dispersant, wherein at least a portion of the attapulgite and a portion of the straight calcined diatomaceous earth and a portion of the flux-calcined diatomaceous earth are in the form of composite particles at least partially surface treated with the dispersant.

In some embodiments, the products disclosed herein may comprise or be: about 9 wt. % to about 90 wt. % sepiolite; about 90 wt. % to about 9 wt. % in aggregate: (a) straight calcined diatomaceous earth and (b) flux-calcined diatomaceous earth; and about 1 wt. % to about 5 wt. % dispersant, wherein at least a portion of the sepiolite and a portion of the straight calcined diatomaceous earth and a portion of the flux-calcined diatomaceous earth are in the form of composite particles at least partially surface treated with the dispersant.

In some embodiments, the products disclosed herein may comprise or be: about 9 wt. % to about 90 wt. % in aggregate (a) attapulgite and (b) sepiolite; about 90 wt. % to about 9 wt. % in aggregate (c) straight calcined diatomaceous earth and (d) flux-calcined diatomaceous earth; and about 1 wt. % to about 5 wt. % dispersant, wherein at least (a) a portion of the attapulgite and (b) a portion of the sepiolite and (c) a portion of the straight calcined diatomaceous earth and flux-calcined diatomaceous earth are in the form of composite particles at least partially surface treated with the dispersant.

Attapulgite is sometimes referred to as palygorskite. To avoid confusion, as used herein, the term “attapulgite” means attapulgite and/or palygorskite. As is known in the art, attapulgite is a chain crystal lattice type of clay mineral that is structurally different from other clays such as montmorillonite or bentonite. Namely, the tetrahedral sheets of attapulgite are divided into ribbons by inversion because adjacent bands of tetrahedra within one tetrahedral sheet point in opposite directions rather than in one direction thus creating a structure of ribbons of 2:1 layers joined at their edges, and the octahedral sheets are continuous in two dimensions only.

Sepiolite is a hydrated magnesium silicate. The structures of both attapulgite and sepiolite are similar in that tetrahedra pointing in the same direction form 2:1 ribbons that extend in the direction of the a-axis and have an average b-axis width of three linked tetrahedral chains in sepiolite and two linked chains in attapulgite. Attapulgite and sepiolite are structurally different than other clays and do not swell with addition of either water or organic solvents. In one embodiment, the product may be substantially free of kaolinite or talc.

Diatomaceous earth (DE), sometimes called diatomite or kieselguhr, is a sedimentary rock that comprises the remnant skeletons of diatoms, single-celled plants that inhabit the surface of many stationery bodies of water, and other minerals, (e.g., clays, volcanic ash, calcite, dolomite, feldspars and silica sand). As is known in the art, the diatoms skeletal structure may comprise pores such as macropores, mesopores and micropores. Straight calcination and flux-calcination are common terms used to describe processes used to agglomerate the particles contained in diatomite ore. In both types of calcination processes, the diatomaceous earth is typically heated in a rotary kiln or the like. Flux-calcined diatomaceous earth (diatomite) has undergone the process of flux-calcination, which promotes a lower softening temperature and a higher degree of particle agglomeration of the diatomite particles contained in diatomite ore. In the flux-calcination process, a fluxing agent is added to the diatomite powder before or during heating of the diatomite powder (typically in a rotary kiln), typically at a temperature range of about 900° C. to about 1250° C., which partially or fully dehydrates the naturally-occurring hydrated amorphous silica structure of the diatomite. Straight calcined diatomaceous earth has undergone the process of straight calcination, which is similar to flux-calcination except that straight calcination does not involve the addition of a fluxing agent. Adding a fluxing agent further promotes the sintering of the diatomite particles and increases the average particle size, porosity and the permeability beyond that achieved by straight calcination (calcination without a fluxing agent). Typical fluxing agents utilized may include, but are not limited to, sodium carbonate, potassium carbonate, sodium chloride and other alkali metal fluxes.

In any one of the embodiments above the product may have a surface area in the range of about 1 meter squared per gram (m²/g) to about 280 m²/g as measured using the Brunauer-Emmett-Teller (BET) theory. In a refinement, when the product comprises composite particles that have been surface treated with a dispersant and comprise attapulgite and diatomaceous earth, the product may have a surface area in the range of about 1 m²/g to about 185 m²/g as measured using the Brunauer-Emmett-Teller (BET) theory. In a refinement, when the product comprises composite particles that have been surface treated with a dispersant and comprise sepiolite and diatomaceous earth, the product may have a surface area in the range of about 20 m²/g to about 280 m²/g as measured using the Brunauer-Emmett-Teller (BET) theory.

In any one of the embodiments above the attapulgite used as a feed material may have a surface area in the range of about 90 m²/g to about 185 m²/g, or about 110 m²/g to about 156 m²/g, or about 135 m²/g to about 150 m²/g as measured using the Brunauer-Emmett-Teller (BET) theory.

In any one of the embodiments above the sepiolite used a feed material may have a surface area in the range of about 150 m²/g to about 280 m²/g, or about 245 m²/g to about 280 m²/g, or about 260 m²/g to about 280 m²/g as measured using the Brunauer-Emmett-Teller (BET) theory.

In any one of the embodiments above the diatomaceous earth used a feed material may have a surface area in the range of about 0.5 m²/g to about 10 m²/g, or about 0.5 m²/g to about 6 m²/g as measured using the Brunauer-Emmett-Teller (BET) theory.

In any one of the embodiments above, such product may have a particle size distribution having a d₅₀ of about 5 microns to about 40 microns (μm), or about 8 microns to about 37 microns, or about 10 microns to about 34 microns. In an embodiment, attapulgite used as feed material may have a particle size distribution having a d₅₀ of: about 3 microns to about 22 microns, or about 5 microns to about 16 microns, or about 6 microns to about 10 microns. In an embodiment, sepiolite used as feed material may have a particle size distribution having a d₅₀ of: about 5 microns to about 19 microns, or about 9 microns to about 18 microns, or about 11 microns to about 16 microns. In an embodiment, diatomaceous earth used as feed material may have a particle size distribution having a d₅₀ of: about 15 microns to about 50 microns, or about 22 microns to about 44 microns, or about 27 microns to about 42 microns.

In any one of the embodiments above, such product may have a particle size distribution having a d₁₀ of about 1 micron to about 15 microns, or about 2 microns to about 14 microns, or about 3 microns to about 12 microns. In an embodiment, attapulgite used as feed material may have a particle size distribution having a d₁₀ of: about 0.7 micron to about 7 microns, or about 1 micron to about 6 microns, or about 2 microns to about 5 microns. In an embodiment, sepiolite used as feed material may have a particle size distribution having a d₁₀ of: about 1 micron to about 8 microns, or about 2 microns to about 7 microns, or about 3 microns to about 6 microns. In an embodiment, diatomaceous earth used as feed material may have a particle size distribution having a d₁₀ of: about 4 microns to about 15 microns, or about 6 microns to about 13 microns, or about 7 microns to about 11 microns.

In any one of the embodiments above, such product may have a particle size distribution having a d₉₀ of: about 30 microns to about 120 microns, or about 40 microns to about 110 microns, or about 50 microns to about 95 microns. In an embodiment, attapulgite used as feed material may have a particle size distribution having a d₉₀ of: about 9 microns to about 70 microns, or about 12 microns to about 45 microns, or about 15 microns to about 18 microns. In an embodiment, sepiolite used as feed material may have a particle size distribution having a d₉₀ of: about 22 microns to about 54 microns, or about 31 microns to about 50 microns, or about 38 microns to about 43 microns. In an embodiment, diatomaceous earth used as feed material may have a particle size distribution having a d₉₀ of: about 50 microns to about 150 microns, or about 80 microns to about 130 microns, or about 99 microns to about 112 microns.

In any one or more of the embodiments above, the product may have a median pore diameter of about 2 microns to about 10 microns, a pore volume of about 1 mL/g to about 4 mL/g, and a bulk density of about 50 kg/m³-about 300 kg/m³.

In any one or more of the embodiments above, the product may be adapted to reduce a filtration pressure of a mine tailing slurry after a dispersal of a dosage amount of the product in the mine tailing slurry, wherein prior to the dispersal of the dosage amount of the product, the mine tailing slurry comprises solids and a liquid, wherein further the solids may comprise mineral solid particulates. In some embodiments, the mineral solid particulates may include or be metal particulates. In a refinement, the product may be adapted to reduce the filtration pressure by about 0.01% to about 20%. In another refinement, the product may be adapted to reduce the filtration pressure of the mine tailing slurry by about 0.01% to about 30% more than a same amount of attapulgite dispersed in the mine tailing slurry.

In any one of the embodiments above, the dispersant may comprise or may be sodium polyacrylate, tetrasodium pyrophosphate (TSPP), sodium silicate, sodium tripolyphosphate (STPP), sodium hexametaphosphate (SHMP), or the like. In one embodiment, the dispersant may include or may be sodium polyacrylate and have a molecular weight in the range of 1,000-10,000 daltons.

In any one of the embodiments above, the product may be adapted to: (a) provide about 0.01% to about 15% decrease in viscosity of the mine tailing slurry after dispersal of the dosage amount of the product in the mine tailing slurry; and/or (b) increase a pump efficiency and/or a flow rate of the mine tailing slurry after a dispersal of the dosage amount of the product in the mine tailing slurry. In a refinement, such product may be adapted to reduce a viscosity of a slurry by about 0.01% to about 15% or about 0.01% to about 11% at shear rate of 10 s⁻¹ as measured in the slurry (after dispersal in the slurry of a solid loading dosage of the product of about 0.01 wt. % to about 3 wt. % or about 0.02 wt. % to about 0.04 wt. % of a dry weight of the solids of the mine tailing slurry) as compared to the viscosity of the slurry when free of the product. Wherein the slurry, before dispersal of the product in the slurry, may comprise about 37.8 wt. % to about 38.2 wt. % solids, the solids including mineral mine tailings (particulates in powder form). In any one of the embodiments above, such product may be adapted to reduce a viscosity of a slurry by about 0.01% to about 15% or about 0.01% to about 11% at shear rate of 50 s⁻¹ as measured in the slurry (after dispersal in the slurry of a solid loading dosage of the product of about 0.01 wt. % to about 3 wt. % or about 0.02 wt. % to about 0.04 wt. % of a dry weight of the solids of the mine tailing slurry) as compared to the viscosity of the slurry when free of the product. Wherein the slurry, before dispersal of the product in the slurry, may comprise about 37.8 wt. % to about 38.2 wt. % solids, the solids including mineral mine tailings. In any one of the embodiments above, the pump efficiency of the slurry and/or a flow rate of the mine tailing slurry (after dispersal in the slurry of a solid loading dosage of the product of about 0.01 wt. % to about 3 wt. % or about 0.02 wt. % to about 0.04 wt. % of a dry weight of the solids of the mine tailing slurry) is increased by about 0.01% to about 15% or about 0.01% to about 11% as compared to the pump efficiency and/or a flow rate of the slurry when free of the product.

In any one or more of the embodiments above, the attapulgite or sepiolite may be in powder form. In any one or more of the embodiments above, the attapulgite or sepiolite may be free of spray drying.

### Description of Test Methods

### Particle Size Analysis

Particle size distribution was measured using Mastersizer 3000 laser particle analyzer equipped with a hydro MV dispersion unit (Malvern Panalytical Inc., MA). The settings used for the particle size distribution measurement consisted of a refractive index of 1.52, an absorption index of 0.01, and attapulgite density 2.3 grams per cubic centimeter (g/cm³), with six-minute sonication at 2,500 revolutions per minute (rpm), and a two-minute pre-measurement delay. For measuring sepiolite, a sepiolite density of 2-2.3 g/cm³ was used. Once the instrument was ready to load the sample, a clean pipette was used to pick up the created slurry and add enough into the hydro MV dispersion unit tank until the obscuration was green. A total of five measurements were taken for each sample and an average particle size distribution generated.

### Surface Area, Pore Volume, Pore Size Distribution

Surface area was measured by the nitrogen adsorption method of the BET (Brunauer-Emmett-Teller) method. Pore volume and pore size distribution of a sample of material was determined by mercury porosimetry. The mercury porosimetry uses mercury as an intrusion fluid to measure pore volume of a (weighed) sample of material enclosed inside a sample chamber of a penetrometer. The sample chamber is evacuated to remove air from the pores of the sample. The sample chamber and penetrometer are filled with mercury. Since mercury does not wet the material surface, it must be forced into the pores by means of external pressure. Progressively higher pressure is applied to allow mercury to enter the pores. The required equilibrated pressure is inversely proportional to the size of the pores, only slight pressure is required to intrude the mercury into macropores, whereas much greater external pressure is required to force mercury into small pores. The penetrometer reads the volume of mercury intruded and the intrusion data is used to calculate pore size distribution, porosity, average pore size and total pore volume. A Micromeritics AutoPore IV 9500 was used to analyze the samples herein.

Assuming pores of cylindrical shape, a surface distribution may be derived from the pore volume distribution for use in calculations. An estimate of the total surface area of the sample of material may be made from the pressure/volume curve (Rootare, 1967) without using a pore model as

$$A = \frac{1}{γ cos θ} {{\int }_{{V}_{Hg , o}}}^{{V}_{Hg , m ax}} p d V$$

Where, A=total surface area
γ=surface tension of the mercury
θ=angle of contact of mercury with the material pore wall
p=external applied pressure
V=pore volume
   From the function V=V(p) the integral may be calculated by means of a numerical method.

From the pressure versus the mercury intrusion data, the instrument generates volume and size distribution of pores following the Washburn equation (Washburn, 1921) as:

$${d}_{i} = \frac{4 γ cos θ}{{P}_{i}}$$

Where, dᵢ=diameter of pore at an equilibrated external pressure
γ=surface tension of the mercury
θ=angle of contact of mercury with the material pore wall
Pᵢ=external applied pressure

The average pore diameter is determined from cumulative intrusion volume and total surface area of the sample of material as:

$$D = \frac{4 V}{S}$$

Where, D=average pore diameter
V=total intrusion volume of mercury
S=total surface area

### Shear Rate

Shear represents relative motion between adjacent layers of a moving liquid. Shear rate is the measure of the extent or rate of relative motion between adjacent layers of a moving liquid. Shear Rate may be calculated by the following formula:

$$Shear Rate = Velocity / Distance$$

### Test Method—for Slurry Viscosity at Different Shear Rates

Viscosity in a slurry at a selected shear rate may be measured and used to compare different materials. About 455 grams (g) of mine tailings slurry was used for each rheology test. Before taking samples, the slurry of mine tailings was mixed vigorously, and the solids content of the slurry was measured with a moisture balance to make sure that the percent solids of the slurry was approximately 38 wt. % for all samples tested. A wax film was used to cover the plastic container with the mine tailings slurry during rheology testing to avoid evaporation.

Rheology measurements were done with a Brookfield R/S+ rheometer (Middleboro, Massachusetts) coupled with a vane geometry immersed into each slurry sample in an open container. Since small variations in solid concentration can result in significant differences in rheology results for the slurry used, a control sample (mine tailing slurry without attapulgite/composite addition) was tested first before the addition of each additive (attapulgite or composite) to the mine tailing slurry. More specifically, after measuring the rheology of a control sample of the slurry, the mineral or composite was added to the slurry at 0.03 wt. % based on the slurry dry solids, and for simplicity, mixing was done with the vane. Two tests were created in the Brookfield rheometer software: one for the control sample of the slurry, and one that included a mixing time for the control sample of the slurry with the added attapulgite or composite.

The rheology of the control sample of the slurry was measured in three steps: 3-minute mixing with the vane producing a shear rate of 180 reciprocal seconds (s⁻¹), a 5-second resting period, and a shear rate increase with a logarithmic ramp from 0.025 to 50 (s⁻¹). The steps to measure the rheology of the control sample with the added attapulgite or composite were the same, except that the first step or mixing time lasted for 13 minutes to ensure a good mixing. The resulting rheograms show the difference between tested samples, at specific shear rates that may be selected (e.g., 10 s⁻¹ and 50 s⁻¹) to compare apparent viscosities of the slurry samples.

### Preparation of the Products

The method of producing the products discussed above may comprise selecting a clay for processing. The clay may comprise, or may be, (a) attapulgite, or (b) sepiolite, or (c) attapulgite and sepiolite. Attapulgite/palygorskite is a magnesium aluminium phyllosilicate with the chemical formula (Mg,Al)₂Si₄O₁₀(OH)·₄H₂O. Sepiolite is a fibrous hydrated magnesium silicate with the chemical formula Mg₄Si₆O₁₅(OH)₂·6H₂O. The percentages of the various elements may vary depending on the deposit from which the attapulgite or sepiolite is sourced. Both minerals have similar crystal structure with three linked tetrahedral chains in sepiolite and two linked chains in attapulgite.

In any one or more of the embodiments above, the clay feed material may be free of spray drying.

The attapulgite selected may have a surface area in the range of about 90 m²/g to about 185 m²/g, or about 110 m²/g to about 156 m²/g, or about 135 m²/g to about 150 m²/g as measured using the Brunauer-Emmett-Teller (BET) theory, and a particle size distribution having a d₅₀ of: about 3 microns to about 22 microns, or about 5 microns to about 16 microns, or about 6 microns to about 10 microns. In a further refinement, the attapulgite used as feed material may have a particle size distribution having a d₁₀ of: about 0.7 micron to about 7 microns, or about 1 micron to about 6 microns, or about 2 micron to about 5 microns. In a refinement, the attapulgite used as feed material may have a particle size distribution having a d₉₀ of: about 9 microns to about 70 microns, or about 12 microns to about 45 microns, or about 15 microns to about 18 microns.

The sepiolite selected may have a surface area in the range of about 150 m²/g to about 280 m²/g, or about 245 m²/g to about 280 m²/g, or about 260 m²/g to about 280 m²/g as measured using the Brunauer-Emmett-Teller (BET) theory, and particle size distribution having a d₅₀ of: about 5 microns to about 19 microns, or about 9 microns to about 18 microns, or about 11 microns to about 16 microns. In a refinement, the sepiolite used as feed material may have a particle size distribution having a d₉₀ of: about 22 microns to about 54 microns, or about 31 microns to about 50 microns, or about 38 microns to about 43 microns. In a further refinement, the sepiolite used as feed material may have a particle size distribution having a d₁₀ of: about 1 micron to about 8 microns, or about 2 microns to about 7 microns, or about 3 microns to about 6 microns.

In each of the embodiments and refinements above, the attapulgite or sepiolite (feed material) may include about 7 to about 16 wt. % or about 9 to about 14 wt. % moisture (measured at 104° C. (220° F.)). The attapulgite may comprise a plurality of rod shaped attapulgite particles.

The method of producing the novel products herein further comprises selecting a diatomaceous earth (also referred to as diatomite) for processing. Siliceous sedimentary rock with the chemical formula of SiO₂. The diatomite may be calcined or flux-calcined, and may have a high surface area in the range of about 0.5 m²/g to about 10 m²/g, or about 0.5 m²/g to about 6 m²/g, as measured by the nitrogen adsorption method based on the Brunauer-Emmett-Teller (BET) theory, and a particle size (d₅₀) (as measured by a laser particle size analyzer) of about 15 microns to about 50 microns, or about 22 microns to about 44 microns, or about 27 microns to about 42 microns. In any one or more of the embodiments, the diatomite selected as feed material may have a particle size distribution of d₉₀ (as measured by a laser particle size analyzer) of about 50 microns to about 150 microns, about 80 microns to about 130 microns, or about 99 microns to about 112 microns. In a further refinement, the particle size (d₁₀) of the diatomite selected as feed material, as measured by a laser particle size analyzer, may be about 4 microns to about 15 microns, or about 6 microns to about 13 microns, or about 7 microns to about 11 microns. In each of the embodiments and refinements above, the diatomite (feed material) may include about 0.4 wt. % to about 5 wt. % moisture at 104° C. (220° F.).

The process further includes preparing a surface treating solution that comprises a dispersant and a liquid. The preparing includes mixing the dispersant with the liquid until well mixed to form the surface treating solution. In an embodiment, the dispersant may be or may comprise sodium polyacrylate, tetrasodium pyrophosphate (TSPP), sodium silicate, sodium tripolyphosphate (STPP), sodium hexametaphosphate (SHMP), or the like. In one embodiment, the dispersant may be or may comprise sodium polyacrylate and have a molecular weight in the range of 1,000-10,000 daltons. The liquid may be or may comprise water or Deionized (DI) water or the like. For example, in one embodiment, a surface treating solution was prepared by mixing 3 grams of sodium polyacrylate dispersant BCS 4010 (Bulk Chemical Services, Sandersville, Georgia) in 10 g of DI water for 10 minutes in a 100 milliliter (ml) glass beaker on a magnetic stirrer plate.

The process further includes mixing until well combined the diatomaceous earth feed material with the attapulgite and/or sepiolite feed material to form a mineral mixture.

The process further includes adding the surface treating solution to the mineral mixture and mixing the surface treating solution and mineral mixture until well mixed to form a composite material.

The process further includes drying the composite material until the moisture content is about 12 wt. % to about 14 wt. %, or about 13 wt. % for the composite material. For example, in an embodiment, the drying of the composite material was at 100° C. in an oven. In other embodiments the temperature range for drying may be about 60° C. to about 200° C. or about 60° C. to about 150° C. so long as the appropriate moisture content in the dried material is about 12 wt. % to about 14 wt. %, or about 13 wt. %, and the dispersant is not burned off of the composite material.

### EXAMPLES

The products of Examples 1-9 were prepared from the different feed materials listed in Table 1.

TABLE 1
Feed Materials.

| | | Surface | | | | Pore | | Bulk |
|---|---|---|---|---|---|---|---|---|
| | Feed | Area | d10 | d50 | d90 | Volume | Porosity | Density |
| | material | (m²/g) | (μm) | (μm) | (μm) | (mL/g) | (%) | (kg/m³) |
| Feed | Speedplus | 0.7 | 9.29 | 35.5 | 106 | 2.0361 | 81.8 | 277 |
| Material | (Flux- | | | | | | | |
| A | calcined | | | | | | | |
| | diatomaceous | | | | | | | |
| | earth) | | | | | | | |
| Feed | Min-U-Gel | 142 | 3.29 | 8.70 | 16.53 | 1.4806 | 73.6 | 365 |
| Material | 400 ® | | | | | | | |
| B | | | | | | | | |
| Feed | Natural | 272 | 5.32 | 14.2 | 41.0 | 3.4586 | 84.5 | 120 |
| Material | Sepiolite | | | | | | | |
| C | | | | | | | | |

Feed material A was prepared using the commercially available Speedplus™ (Dicalite, Pennsylvania), a flux-calcined diatomaceous earth product, as feed material. Feed material A contained less than 0.5 wt. % moisture.

The major elemental composition of Feed Material A, as determined by semiquantitative spectrographic analysis (as disclosed in associated Dicalite Brochure) is shown in Table 2.

TABLE 2
Major Oxide Composition of flux-calcined product
Speedplus (Dicalite, Pennsylvania) used as feed material.
Total Chemistry for Speedplus (expressed as oxides)

| | |
|---|---|
| SiO₂ (wt. %) | 95 |
| Al₂O₃ (wt. %) | 2 |
| Fe₂O₃ (wt. %) | 1 |
| CaO (wt. %) | 0.2 |
| MgO (wt. %) | 0.1 |
| Na₂O (wt. %) | 1.6 |
| K₂O (wt. %) | 0.08 |
| TiO₂ (wt. %) | 0.1 |
| Moisture content, wt. % | <0.5 |
| Residue (wet) % retained on 140 mesh screen | Max. 8 |
| Residue (wet) % retained on 325 mesh screen | Max. 27 |

Feed Material B was prepared using the commercially available Min-U-Gel 400® (Active Minerals International, LLC) as feed material. The Min-U-Gel 400 product is a non-purified natural attapulgite that has been air classified. The major elemental compositions of Min-U-Gel 400, as determined by wave-length dispersive x-ray fluorescence (XRF) analysis, is shown in Table 3. Feed material B contained about 13 wt. % to about 14 wt. % free moisture at 104° C.).

TABLE 3
Major Oxide Composition of air classified
natural attapulgite Min-U-Gel 400 used as
feed materials (Ignited Basis).
Total Chemistry for Min-U-Gel 400 as
determined by XRF (expressed as oxides) ¹

| | |
|---|---|
| SiO₂ (wt. %) | 66.2 |
| Al₂O₃ (wt. %) | 12.1 |
| Fe₂O₃ (wt. %) | 4.2 |
| CaO (wt. %) | 2.8 |
| MgO (wt. %) | 9.9 |
| Na₂O (wt. %) | |
| K₂O (wt. %) | 1.1 |
| TiO₂ (wt. %) | 0.6 |
| P₂O₅ (wt. %) | 1.0 |
| Free Moisture, wt. % @ 220° F. (104° C.) | 13.5 |
| Residue (wet) % retained on 325 mesh screen | 0.005 |

¹ Although the elements are reported as oxides, they are actually present as complex aluminosilicates.

Feed Material C was prepared using natural sepiolite obtained from Sigma-Aldrich. The natural sepiolite contained about 13 wt. % magnesium (Mg). Feed material C had a high surface area of about 272 m²/g, as measured by the nitrogen adsorption method based on the Brunauer-Emmett-Teller (BET) theory. Particle size (d₅₀) of this feed material, as measured by a laser particle size analyzer, was about 14.2 microns. The sepiolite feed material was in powder form and was free of extrusion. Feed material C contained about 9.7 wt. % moisture (as determined by loss on drying). The Certificate of Analysis (COA) of the sepiolite is shown in Table 4.

TABLE 4
Certificate of analysis (COA) of natural sepiolite used as feed materials.
Certificate of analysis for natural sepiolite

| | |
|---|---|
| Mg (wt. %) as determined by Atomic Absorption | 13 |
| Loss on drying (moisture content) wt. % | 9.7 |
| Loss on ignition wt. % | 17.7 |

### Example 1

Example 1 was prepared by mixing 100 grams (g) of Feed Material B (attapulgite) with 13 g of a surface treating solution in a KitchenAid 5-quart food mixer. The surface treating solution was prepared by mixing 3 g of sodium polyacrylate dispersant BCS 4010 (Bulk Chemical Services, Sandersville, Georgia) in 10 g of DI water for 10 minutes in a 100 ml glass beaker on a magnetic stirrer plate. After mixing for 15 minutes at low speed, the mixture of attapulgite with surface treating solution was dried at 100° C. in an oven for 15-30 minutes until mixture moisture level was around 13% as determined by a moisture balance with temperature setting at 190° C.

### Examples 2, 4 and 6

Examples 2, 4, 6 were prepared by mixing respective amounts of Feed Material B (attapulgite) and Feed Material A (diatomaceous earth) (see Table 5) in a KitchenAid 5-quart food mixer for 15 minutes, and then drying the resulting mixtures of attapulgite and diatomaceous earth at 100° C. in an oven for 15-30 minutes until mixture moisture level was around 13% as determined by a moisture balance with temperature setting at 190° C. No dispersant was applied to the mixtures of Examples 2, 4 and 6. Table 5 identifies the respective amount of feed material for each of Examples 2, 4 and 6.

TABLE 5
Formulations for Examples 1-9.

| | | | | | | Dispersant | Dispersant |
|---|---|---|---|---|---|---|---|
| | Attapulgite | Sepiolite | DE | | DI | in | in |
| | (Feed B) | (Feed C) | (Feed A) | Dispersant | water | solution | composite |
| Ex | (g) | (g) | (g) | (g) | (g) | (wt. %) | (wt. %) |
| Ex 1 | 100 | | | 3 | 10 | 23 | 2.9 |
| Ex 2 | 80 | | 20 | | | | |
| Ex 3 | 80 | | 20 | 3 | 10 | 23 | 2.9 |
| Ex 4 | 50 | | 50 | | | | |
| Ex 5 | 50 | | 50 | 3 | 10 | 23 | 2.9 |
| Ex 6 | 30 | | 70 | | | | |
| Ex 7 | 30 | | 70 | 3 | 10 | 23 | 2.9 |
| Ex 8 | | 80 | 20 | 3 | 10 | 23 | 2.9 |
| Ex 9 | | 50 | 50 | 3 | 10 | 23 | 2.9 |

### Examples 3, 5 and 7

Examples 3, 5, 7 were prepared by first mixing respective amounts of Feed Material B (attapulgite) and feed Material A (diatomaceous earth) in a KitchenAid 5-quart food mixer for 15 minutes. A surface treating solution was prepared by mixing 3 g of sodium polyacrylate dispersant BCS 4010 (Bulk Chemical Services, Sandersville, Georgia) in 10 g of DI water for 10 minutes in a 100 ml glass beaker on a magnetic stirrer plate. The surface treating solution was then added to the resulting attapulgite and diatomaceous earth mixture. After mixing for 15 minutes at low speed, the mixtures were dried at 100° C. in an oven for 15-30 minutes until mixture moisture level was around 13 wt. %. Table 5 identifies the respective amount of feed material, dispersant and DI water for each of Examples 3, 5 and 7.

### Examples 8-9

Examples 8 to 9 were prepared using the same method as used for Examples 3, 5 and 7 except feed Material C (sepiolite) was used instead of Feed Material B (attapulgite). Table 5 identifies the respective amount of feed material, dispersant and DI water for each of Examples 8-9.

For each of Examples 1-9, particle size distribution is shown in the Table 6 below. To obtain particle size distribution in Table 6, particle size analysis was done on five representative samples of each of Examples 1-9. The results of the five representative samples were averaged to determine the average or typical particle size distribution shown in Table 6 for each of Examples 1-9. Porosimetry, surface area and bulk density data for Feed Materials A-C, and Examples 3, 5, 7, 8 and 9 are shown in Table 7. Pore volume was measure in milliliters per gram (mL/g). Bulk density was measured in kilograms per cubic meter (kg/m³).

TABLE 6
Particle size of Examples 1-9.

| Examples | d10 (μm) | d50 (μm) | d90 (μm) |
|---|---|---|---|
| Example 1 | 4.54 | 9.12 | 19.1 |
| Example 2 | 5.26 | 11.5 | 29.0 |
| Example 3 | 4.40 | 12.8 | 53.9 |
| Example 4 | 5.66 | 14.7 | 56.0 |
| Example 5 | 10.2 | 29.8 | 90.3 |
| Example 6 | 6.29 | 18.5 | 57.3 |
| Example 7 | 10.1 | 28.3 | 69.5 |
| Example 8 | 5.90 | 18.2 | 52.8 |
| Example 9 | 6.79 | 22.1 | 64.4 |

TABLE 7
Porosimetry, surface area and bulk density data

| | Median pore | Pore | Surface | Bulk |
|---|---|---|---|---|
| | diameter | volume | area | Density |
| Examples | (um) | (mL/g) | (m²/g) | (kg/m³) |
| Speedplus | 9.458 | 2.0361 | 0.7 | 277 |
| Min-U-Gel 400 | 1.867 | 1.4806 | 134 | 365 |
| Sepiolite | 2.716 | 3.4586 | 278 | 120 |
| Example 3 | 2.679 | 1.4698 | 88 | 197 |
| Example 5 | 8.284 | 1.5127 | 43 | 161 |
| Example 7 | 5.885 | 1.6263 | 22 | 161 |
| Example 8 | 3.077 | 2.8061 | 192 | 72 |
| Example 9 | 5.056 | 2.4598 | 105 | 94 |

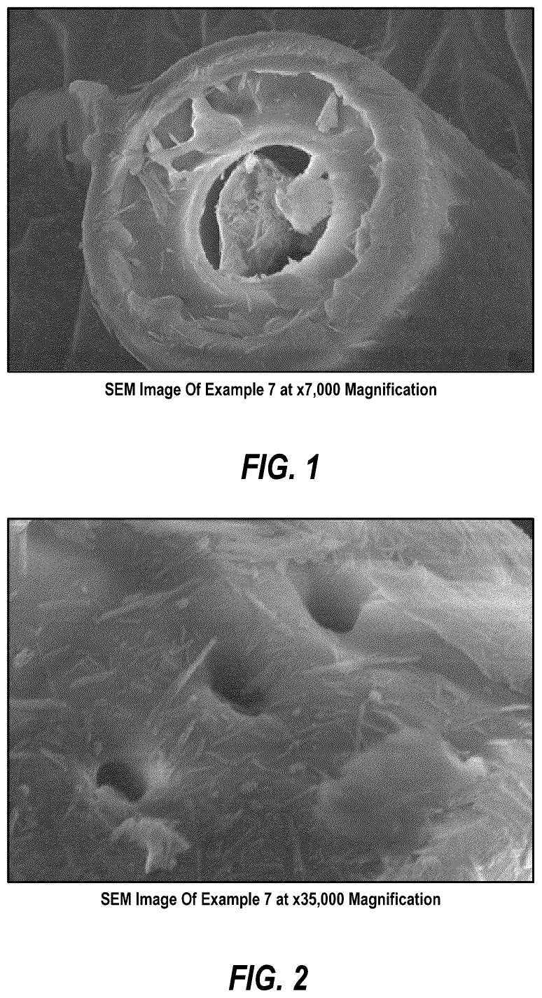

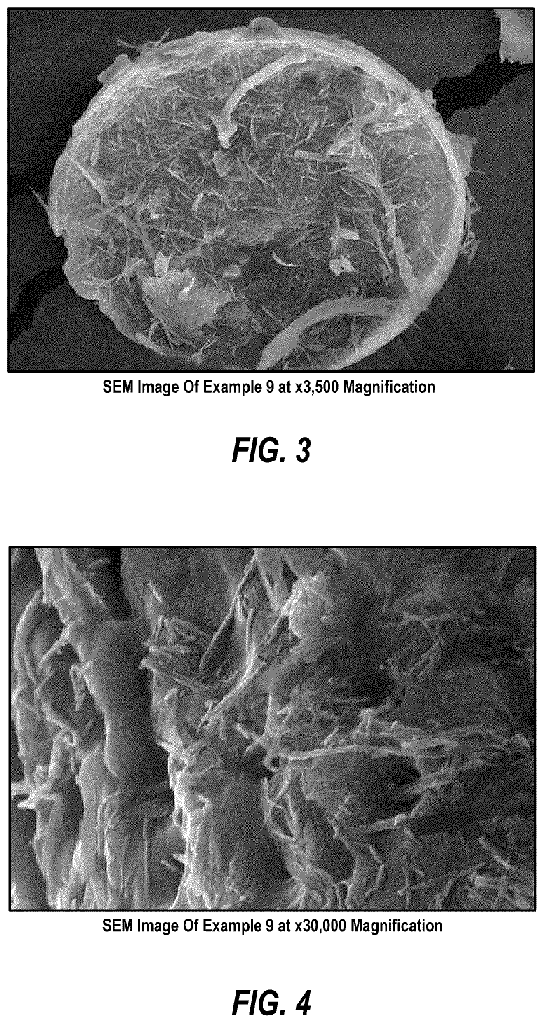

As a result of this process a portion the clay particles and diatomaceous earth particles are agglomerated to form surface treated composite particles in which one or more clay particles are attached to an outer surface of a diatomite particle or one or more pores of a diatomite particle contain one or more clay particles (one or more clay particles are disposed inside one or more large diatom pores). Pore size of the surface treated composites that comprise attapulgite and diatomaceous earth, and of the surface treated composites that comprise sepiolite and diatomaceous earth are significantly bigger than the respective feed materials of attapulgite or sepiolite. Bulk density of the surface treated composites that comprise attapulgite and diatomaceous earth, and of the surface treated composites that comprise sepiolite and diatomaceous earth is significantly lower than the respective feed materials of attapulgite or sepiolite due to the agglomerated large composite particles. The products disclosed herein that comprise the surface treated composite may have a median pore diameter of about 2 microns to about 10 microns, and/or a pore volume of about 1 mL/g to about 4 mL/g, and/or a bulk density of about 50 kg/m³ to 300 kg/m³. FIG. 1 is a SEM image of Example 7 at a magnification of ×7000 illustrating rod shaped attapulgite particles disposed inside the large pores of a diatomite particle, and FIG. 2 is a SEM image of Example 7 at a magnification of ×35,000 illustrating rod shaped attapulgite particles attached to the surface of diatomite particle and inside the large diatom pores. FIG. 3 is a SEM image of Example 9 at a magnification of ×3500 illustrating long rod shaped sepiolite particles attached to the surface of a diatomite particle, and FIG. 4 is a SEM image of Example 9 at a magnification of ×30000 illustrating sepiolite particles attached to the surface of a diatomite particle and inside the large diatom pores.

Each of the examples above were tested for use with a rare earth mine tailing slurry to determine effects on viscosity (and by extension pump efficiency), and pressure during filtration to de-water the mine tailing slurry.

Viscosity in a mine tailing slurry at a selected shear rate was measured and used to compare the effect on the slurry of the addition of different materials. About 455 g sample of a rare earth mine tailings slurry was used for each rheology test. Before taking samples, the slurry of mine tailings (from which the sample was to be taken) was mixed vigorously, and the solids content of such slurry was measured with a moisture balance to make sure that the percent solids of the slurry was approximately 38 wt. % for all samples tested. A wax film was used to cover the plastic container with the rare earth or copper mine tailings slurry during rheology testing to avoid evaporation.

Rheology measurements were done with a Brookfield R/S+ rheometer (Middleboro, Massachusetts) coupled with a vane geometry immersed into each slurry sample in an open container. Since small variations in solid concentration can result in significant differences in rheology results for the slurry used, a control sample (mine tailing slurry without attapulgite/composite addition) was tested first before the addition of each additive (attapulgite or composite) to the mine tailing slurry. More specifically, after measuring the rheology of a control sample of the slurry, the mineral or composite was added to the slurry at 0.03 wt. % based on the slurry dry solids, and for simplicity, mixing was done with the vane. Two tests were created in the Brookfield rheometer software: one for the control sample of the slurry, and one that included a mixing time for the control sample of the slurry with the added attapulgite or composite.

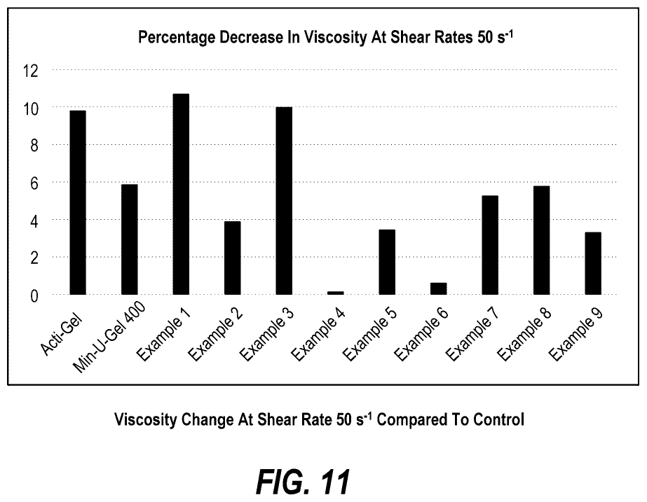

The rheology of the control sample of the slurry was measured in three steps: 3-minute mixing with the vane producing a shear rate of 180 reciprocal seconds (s⁻¹), a 5-second resting period, and a shear rate increase with a logarithmic ramp from 0.025 to 50 (s⁻¹). The steps to measure the rheology of the control sample with the added mineral or composite were the same, except that the first step or mixing time lasted for 13 minutes to ensure a good mixing. The resulting rheograms show the difference between tested samples, at specific shear rates that may be selected (e.g., 10 s⁻¹ and 50 s⁻¹) to compare apparent viscosities of the slurry samples. FIG. 10 is a graph illustrating the percentage decrease in viscosity at shear rate 10 s⁻¹ of rare earth mine tailing slurries comprising one of Examples 1-9, or commercially available Acti-Gel, or Min-U-Gel 400, as compared to the viscosity of the control sample of the rare earth mine tailing slurry. FIG. 11 is a graph illustrating the percentage decrease in viscosity at shear rate 50 s⁻¹ of rare earth mine tailing slurries comprising one of Examples 1-9, or commercially available Acti-Gel, or Min-U-Gel 400, as compared to the control sample of the rare earth mine tailing slurry.

As is known: “Pump efficiency on slurry may be reduced compared with the water efficiency over the complete flow range. This is not restricted to small pumps. It is due to the increased apparent viscosity. Performance has been found to correlate well with a modified version of the pump Reynolds Number (Rep) as follows:

$$R {e}_{p} = ω \cdot {Di}^{2} \cdot ( {ρ}_{m} ) / η$$

where:
ω=pump rotational speed (l/s)
Di=Impeller diameter (m)
ρₘ=slurry density (kg/m³)
η=Coefficient of rigidity (Pa·s) roughly equal to viscosity

when Reₚ is less than 1×10⁶, efficiency is generally significantly reduced.”

(Liu. W.; Burgess, K.; Roudnev, A.; Bootle, M., Pumping Non-Newtonian Slurries, Weir Minerals Division Technical Bulletin, August 2009, Bulletin #14, version 2, page 3.)

Flow rate, as defined in Poiseuille's law, is inversely proportional to viscosity. As is known in the art, Poiseuille's law describes the smooth flow of a fluid along a tube:

$$F = ( π {r}^{4} Δ p ) / ( 8 η L )$$

Where:
the pressure drop is Δp=p1−p2
r=the radius of the tube
L=the length of the tube
η is viscosity

If r, Δp, and L are constant, the flow rate is:

$$F = k / η$$

where k is constant

The effect of the attapulgite products Min-U-Gel 400, and Acti-Gel, and of Example 1 (attapulgite surface treated with dispersant) on de-watering via pressure filtration of copper mine tailing slurry was tested as compared to a control sample of such mine tailing slurry. For the control sample, the copper mine tailing slurry was mixed with an IKA mixer at 1000 RPM for 10 minutes. After mixing, the solid weight percentage was measured using the moisture balance. For consistency, the solid weight percentage was controlled at about 38% (for all pressure filtration tests). DI water was added to adjust solid weight percentage due to the evaporation. Then, the control sample of the mine tailing slurry having approximately 38 wt. % solids (with no mineral or composite additive) was pumped at a 20 milliliter (ml)/min flow rate through a 39 millimeter diameter pressure filter having a 3 g pre-coat of diatomaceous earth (Speedplus from Dicalite). The pressure of such mine tailing slurry at the filter was measured in kiloPascals (kPa) during the first few minutes of filtering.

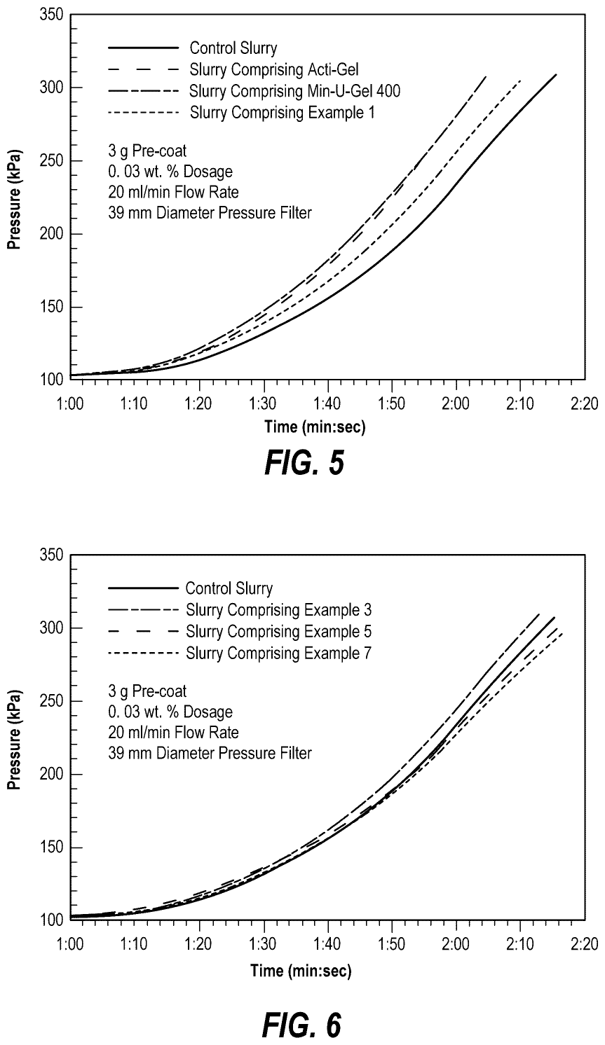

To test the effect of adding Acti-Gel, Min-U-Gel 400 or Example 1 to such a copper mine tailing slurry, samples were prepared of the copper mine tailing slurry with an IKA mixer at 1000 RPM for 10 minutes. After mixing, the solid weight percentage was measured using the moisture balance. As noted earlier, for consistency with the control, the solid weight percentage was controlled at about 38%. DI water was added to adjust solid weight percentage due to the evaporation. Then each sample of the copper mine tailing slurry having approximately 38 wt. % solids was mixed with the 0.03 wt. % dosage (based on slurry solid dry weight) of Acti-Gel, Min-U-Gel 400 or Example 1, respectively, for 20 minutes at 400 RPM on a magnetic stirrer and then pumped at a 20 ml/min flow rate through a 39 millimeter (mm) diameter pressure filter having a 3 g pre-coat of diatomaceous earth (Speedplus). The dosage amount was 0.03 wt. % of the dry weight of the solids in the mine tailing slurry. (For example, in a slurry of 455 g having with 38 wt. % dry solids (about 172.9 g), the 0.03 wt. % dosage is about 0.05187 g.) The pressure of the mine tailing slurry at the filter was measured in kPa during the first few minutes of filtering. FIG. 5 illustrates a graph of the pressure of the respective slurries (measured adjacent to the filter) over approximately the first couple of minutes of filtration. Compared to the control of copper mine tailing (without additive), adding mineral additives of Acti-Gel, Min-U-Gel 400 or Example 1 to the copper mine tailing slurry increases filtration pressure. Example 1 of Min-U-Gel 400 surface treated with dispersant has lower filtration pressure than Acti-Gel and Min-U-Gel 400.

The effect of the Examples 3, 5 and 7 (comprising surface treated composite particles that include attapulgite and diatomaceous earth) on de-watering via pressure filtration of the copper mine tailing slurry was also tested and compared to the test results of the control sample of the copper mine tailing slurry. As noted earlier, for consistency, the mine tailing solid weight percentage before mixing with surface treated composite additives was controlled at about 38% for all pressure filtration tests. DI water was added to adjust solid weight percentage due to the evaporation. Samples were prepared of the copper mine tailing slurry having approximately 38 wt. % solids mixed with 0.03 wt. % dosage (based on slurry solid dry weight) of Examples 3, 5 or 7, respectively, for 20 minutes at 400 RPM on a magnetic stirrer. The sample of the mine tailing slurry having approximately 38 wt. % solids (with composite additive) was pumped at a 20 ml/min flow rate through a 39 millimeter diameter pressure filter having a 3 g pre-coat of diatomaceous earth (Speedplus from Dicalite). The pressure of the mine tailing slurry at the filter was measured in kPa during the first few minutes of filtering. FIG. 6 illustrates a graph of the pressure of the respective copper mine tailing slurries to which a 0.03 wt. % of Examples 3, 5 or 7 had been added, as measured adjacent to the filter over approximately the first couple of minutes of filtration. Example 3 has slightly higher filtration pressure than the control without surface treated composite additive but Examples 5 and 7 have lower filtration pressure than the control.

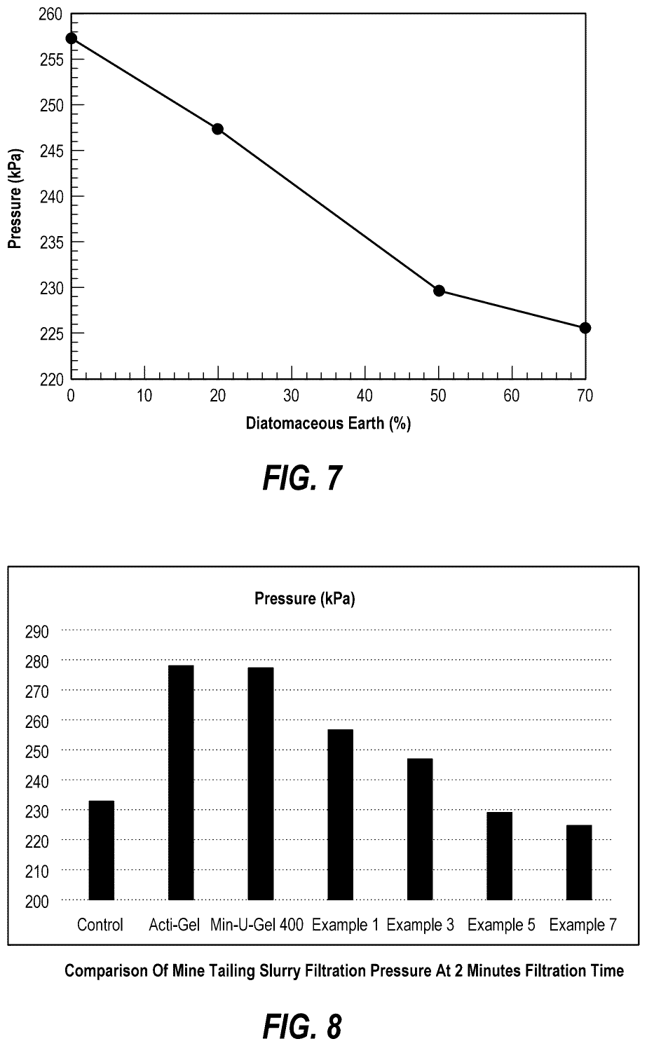

FIG. 7 illustrates the impact of diatomaceous earth content in the composition on mine tailing filtration pressure at two (2) minutes filtration time. As can be seen in FIG. 7, as the percent of diatomaceous earth content increases in the composite, the filtration pressure decreases. FIG. 8 illustrates a comparison of mine tailing filtration pressure at 2 minutes filtration time for the various slurries tested. The inventors found that, while the addition of attapulgite to the slurry increased filtration pressure, the novel composites of Example 5 and 7 with larger pore diameters (Table 7) resulted in less filtration pressure than the control slurry. Although Example 3 has higher pressure than the control slurry, it still has lower filtration pressure than the slurry that includes the attapulgite samples (Acti-Gel, Min-U-Gel 400 and Example 1).

The effect of the Examples 8 and 9 (comprising surface treated composite particles that includes sepiolite and diatomaceous earth) on de-watering via pressure filtration of the rare earth mine tailing slurry were also tested and compared to test results of a control sample of the rare earth mine tailing slurry. For the control sample, the rare earth mine tailing slurry was mixed with an IKA at 1000 RPM for 10 minutes. After mixing, the solid weight percentage was measured using the moisture balance. For consistency, the solid weight percentage was controlled at about 38 wt. % (for all pressure filtration tests). DI water was added to adjust solid weight percentage due to the evaporation. Then, the control sample of the mine tailing slurry having approximately 38 wt. % solids (with no composite additive) was pumped at a 23 ml/min flow rate through a 38 millimeter diameter pressure filter having a 0.5 g pre-coat of diatomaceous earth (Speedplus from Dicalite). The pressure of such mine tailing slurry at the filter was measured in kPa during the first few minutes of filtering.

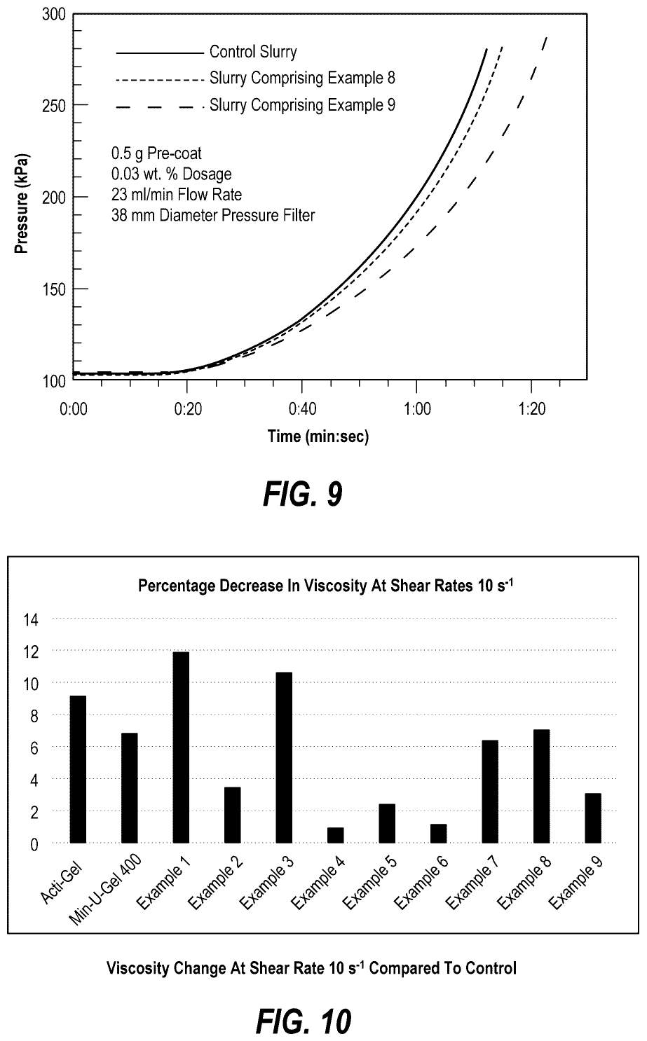

Samples were then prepared of the rare earth mine tailing slurry mixed 0.03 wt. % dosage (based on slurry solid dry weight) of Examples 8 or 9, respectively, for 20 minutes at 400 RPM on a magnetic stirrer. As noted earlier, for consistency, the solid weight percentage was controlled using the moisture balance at about 38 wt. % before mixing with mineral additives for all pressure filtration tests. DI water was added to adjust solid weight percentage due to the evaporation. The sample of the mine tailing slurry having approximately 38 wt. % solids (with the respective composite additive) was pumped at a 23 ml/min flow rate through a 38 millimeter diameter pressure filter having a 0.5 g pre-coat of diatomaceous earth (Speedplus from Dicalite). The pressure of the mine tailing slurry at the filter was measured in kPa during the first few minutes of filtering. FIG. 9 illustrates a graph of the pressure of the control slurry, and the respective rare earth mine tailing slurries to which a 0.03 wt. % dosage of Examples 8 or 9 had been added, as measured adjacent to the filter over approximately the first minute of filtration. Both Examples 8 and 9 have lower filtration pressure than the control slurry similar to Examples 5 and 7.

Table 8 shows a comparison between the filtration pressure at two minutes of the control (copper mine tailing) slurry, and the respective copper mine tailing slurries to which a 0.03 wt. % dosage of Acti-Gel, Min-U-Gel, or Examples 1, 3, 5 or 7 had been added. As can be seen, addition of Acti-Gel (attapulgite), Min-U-Gel (attapulgite), or Example 1 (attapulgite with dispersant) resulted in increased filtration pressure compared to the control slurry. The addition of Examples 3, 5 or 7 to the respective copper mine tailing slurries resulted in lower filtration pressure than did the addition of Acti-Gel (attapulgite), Min-U-Gel (attapulgite) or Example 1. Furthermore, the addition of Examples 5 or 7 to the copper mine tailing slurry resulted in lower filtration pressure than the control slurry. Notably, each of Examples 3, 5 and 7 (composite surface treated with dispersant) resulted in significantly lower filtration pressure than using Min-U-Gel 400 as an additive, which is 100 wt. % attapulgite. Table 9 shows similar results for Examples 8-9. A 0.03 wt. % dosage of Example 8 or 9 (composite surface treated with dispersant) to a rare earth mine tailing slurry lowered the filtration pressure (measured at one minute) as compared to the control (rare earth mine tailing slurry without additive).

TABLE 8
Comparison of filtration pressure at two minutes.

| | Pressure (kPa) | % change | % change vs. attapulgite |
|---|---|---|---|
| | at 2 min | vs. control | (Min-U-Gel 400) |
| Control | 233.1 | | |
| Acti-Gel | 278.24 | 19 | |
| Min-U-Gel 400 | 278.07 | 19 | |
| Example 1 | 257.31 | 10 | −7 |
| Example 3 | 247.45 | 6 | −11 |
| Example 5 | 229.84 | −1 | −17 |
| Example 7 | 225.5 | −3 | −19 |

TABLE 9
Comparison of filtration pressure at one minute.

| | Pressure (kPa) | % change |
|---|---|---|
| | at 1 min | vs. control |
| Control | 202.98 | |
| Example 8 | 191.59 | −6 |
| Example 9 | 173.38 | −10 |

Table 10 shows that surface treating attapulgite has more impact on reducing viscosity compared to untreated samples (Example 1 vs. Min-U-Gel 400, Example 3 vs. Example 2, Example 5 vs. Example 4, Examples 7 vs Example 6). Based on the modified version of the pump Reynolds Number (Rep) discussed herein, pump efficiency (or pumpability) of a mine tailing slurry is inversely proportional to the viscosity of the mine tailing slurry. As such, dispersant (surface) treated composites that comprise (a) attapulgite and diatomaceous earth, or (b) sepiolite and diatomaceous earth, or (c) attapulgite, sepiolite and diatomaceous earth reduce the viscosity of the mine tailing slurry and thus improve pump efficiency of the mine tailing slurry. Although attapulgite (Acti-Gel, Min-U-Gel 400 and Example 1) also has lower viscosity to improve mine tailing pump efficiency, these attapulgite products increase mine slurry filtration dewatering pressure, which is not desirable. The present invention of dispersant treated composites that comprise (a) attapulgite and diatomaceous earth, or (b) sepiolite and diatomaceous earth, or (c) attapulgite, sepiolite and diatomaceous earth reduce the viscosity of the mine tailing slurry to make the mine tailing slurry more flowable (increases the flow rate) and more pumpable and thus improve pump efficiency/pumpability, and also reduce mine tailing slurry dewatering filtration pressure to improve dewatering efficiency.

TABLE 10
Percentage decrease in viscosity in
high clay rare earth mine tailing.

| | Percentage decrease | Percentage decrease |
|---|---|---|
| | in viscosity at | in viscosity at |
| Examples | shear rates 10 s⁻¹ | shear rate 50 s⁻¹ |
| Acti-Gel | 9.18 | 9.78 |
| Min-U-Gel 400 | 6.87 | 5.76 |
| Example 1 | 11.95 | 10.7 |
| Example 2 | 3.49 | 3.91 |
| Example 3 | 10.7 | 9.99 |
| Example 4 | 0.91 | 0.18 |
| Example 5 | 2.44 | 3.46 |
| Example 6 | 1.17 | 0.66 |
| Example 7 | 6.42 | 5.21 |
| Example 8 | 7.06 | 5.77 |
| Example 9 | 3.07 | 3.3 |

Also disclosed is a method of producing the product, the method comprising: selecting a diatomaceous earth as a first feed material; selecting a clay as second feed material, wherein the clay comprises (a) attapulgite or (b) sepiolite or (c) attapulgite and sepiolite; mixing a dispersant solution, the clay and the diatomaceous earth to form a mixture in which a portion the clay and a portion of the diatomaceous earth is agglomerated to form a plurality of composite particles, each composite particle in the plurality comprised of a clay particle attached to an outer surface of a diatomite particle or disposed inside a pore of the diatomite particle, the dispersant solution including a dispersant, wherein the composite particle is at least partially surface treated with the dispersant solution; and drying the mixture. Wherein the product may have a particle size distribution having a d₁₀ of 1-15 microns and d₅₀ of 5-40 microns, a median pore diameter of 2-10 microns, a pore volume of 1-4 mL/g and a bulk density of 50-300 kg/m³. Wherein the product is adapted to reduce a filtration pressure and a viscosity of a mine tailing slurry after a dispersal of the product in the mine tailing slurry that (prior to the dispersal of the product) comprises mineral solid particulates and a liquid. In an embodiment, the product may be adapted to provide 0.01% to 15% decrease in viscosity of the mine tailing slurry after dispersal of the product in the mine tailing slurry.

### INDUSTRIAL APPLICABILITY

In general, the foregoing disclosure finds utility in decreasing dewatering filtration pressure and viscosity of mine tailing slurries and increasing pump efficiency of mine tailing slurries. Since mine tailing pump efficiency is inversely proportional to mine tailing slurry viscosity, dispersant treated composites that comprise (a) attapulgite and diatomaceous earth, or (b) sepiolite and diatomaceous earth, or (c) attapulgite, sepiolite and diatomaceous earth improve mine tailing pump efficiency. Although attapulgite (Acti-Gel, Min-U-Gel 400 and Example 1) also has lower viscosity to improve mine tailing pump efficiency, these attapulgite products increase mine slurry filtration dewatering pressure, which is not desirable. The presently claimed invention of dispersant treated composites that comprise (a) attapulgite and diatomaceous earth, or (b) sepiolite and diatomaceous earth, or (c) attapulgite, sepiolite and diatomaceous earth reduce the viscosity of the mine tailing slurry to make the mine tailing slurry more flowable (increases the flow rate) and more pumpable and thus improve pump efficiency/pumpability (of the mine tailing slurry), and also reduce mine tailing slurry dewatering filtration pressure to improve dewatering efficiency.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A product comprising:
9 wt. %-90 wt. % diatomaceous earth, wherein the diatomaceous earth includes flux-calcined diatomaceous earth or calcined diatomaceous earth;
9 wt. %-90 wt. % clay, the clay comprising (a) attapulgite or (b) sepiolite or (c) attapulgite and sepiolite; and
1 wt. %-5 wt. % dispersant,
wherein a portion the clay and a portion of the diatomaceous earth is agglomerated to form a plurality of composite particles, each composite particle in the plurality comprised of one or more clay particles attached to an outer surface of a diatomite particle or disposed inside a pore of the diatomite particle, wherein the composite particle is at least partially surface treated with the dispersant,
wherein the product has a particle size distribution having a d₅₀ of 5-40 microns, and a d₁₀ of 1-15 microns,
wherein the product has a median pore diameter of 2-10 microns, a pore volume of 1-4 mL/g and a bulk density of 50-300 kg/m³.

2. The product of claim 1,
wherein the product is adapted to reduce a filtration pressure of a mine tailing slurry after a dispersal of a dosage amount of the product in the mine tailing slurry,
wherein prior to the dispersal of the dosage amount of the product, the mine tailing slurry comprises solids and a liquid, wherein the solids comprises mineral solid particulates.

3. The product of claim 2, wherein the product is adapted to reduce the filtration pressure by 0.01% to 20%.

4. The product of claim 3, wherein the product is adapted to reduce the filtration pressure of the mine tailing slurry by 0.01%-30% more than a same amount of attapulgite dispersed in the mine tailing slurry.

5. The product of claim 2, wherein the mineral solid particulates include metal particulates.

6. The product of claim 2, wherein the product is adapted to: (a) provide 0.01% to 15% decrease in viscosity of the mine tailing slurry after dispersal of the dosage amount of the product in the mine tailing slurry; and/or (b) increase a pump efficiency and/or a flow rate of the mine tailing slurry after a dispersal of the dosage amount of the product in the mine tailing slurry.

7. The product of claim 3, wherein the dosage amount is 0.01 wt. %-3 wt. % of a dry weight of the solids of the mine tailing slurry.

8. The product of claim 1, wherein the product has a particle size distribution d₉₀ of 30-120 microns.

9. The product of claim 1, wherein the dispersant comprises sodium polyacrylate, tetrasodium pyrophosphate (TSPP), sodium silicate, sodium tripolyphosphate (STPP), or sodium hexametaphosphate (SHMP).

10. A method of producing a product for reducing filtration pressure and viscosity in a mine tailing slurry, the method comprising:
selecting a diatomaceous earth as a first feed material;
selecting a clay as second feed material, wherein the clay comprises (a) attapulgite or (b) sepiolite or (c) attapulgite and sepiolite;
mixing a dispersant solution, the clay and the diatomaceous earth to form a mixture in which a portion the clay and a portion of the diatomaceous earth is agglomerated to form a plurality of composite particles, each composite particle in the plurality comprised of a clay particle attached to an outer surface of a diatomite particle or disposed inside a pore of the diatomite particle, the dispersant solution including a dispersant, wherein the composite particle is at least partially surface treated with the dispersant solution; and
drying the mixture,
wherein the product has a particle size distribution having a d₁₀ of 1-15 microns,
wherein the product has a particle size distribution having a d₅₀ of 5-40 microns,
wherein the product has a median pore diameter of 2-10 microns, a pore volume of 1-4 mL/g and a bulk density of 50-300 kg/m³,
wherein the product is adapted to reduce a filtration pressure of a mine tailing slurry after a dispersal of the product in the mine tailing slurry,
wherein the product is adapted to provide 0.01% to 15% decrease in viscosity of the mine tailing slurry after dispersal of the product in the mine tailing slurry,
wherein prior to the dispersal of the product, the mine tailing slurry comprises mineral solid particulates and a liquid.

11. The method of claim 10, wherein a weight percentage of components of the product includes 9 wt. %-90 wt. % clay.

12. The method of claim 10,
wherein the diatomaceous earth includes calcined diatomaceous earth or flux-calcined diatomaceous earth,
wherein the product is adapted to reduce the filtration pressure by 0.01% to 20%.

13. The method of claim 10, wherein the product has a surface area of 1-280 m²/g.

14. The method of claim 10, wherein the product has a particle size distribution having a d₉₀ of 30-120 microns.

15. The method of claim 10, wherein the product is adapted to increase a pump efficiency and/or a flow rate of the mine tailing slurry after a dispersal of the product in the mine tailing slurry and as compared the mine tailing slurry when free of the product.

16. The method of claim 10, wherein the dispersant is 1 wt. %-5 wt. % of the product, wherein the dispersant includes sodium polyacrylate, tetrasodium pyrophosphate (TSPP), sodium silicate, sodium tripolyphosphate (STPP), or sodium hexametaphosphate (SHMP).

17. A product comprising:
composite particulates surface treated with a dispersant, the composite particulates comprising:
diatomaceous earth, and
clay comprising (a) attapulgite or (b) sepiolite or (c) attapulgite and sepiolite,
wherein the product has a particle size distribution having a d₅₀ of 5-40 microns and d₁₀ of 1-15 microns,
wherein the product has a median pore diameter of 2-10 microns, a pore volume of 1-4 mL/g and a bulk density of 50-300 kg/m³,
wherein the product has a surface area of 1-280 m²/g,
wherein the product is adapted to reduce by 0.01% to 20% a filtration pressure of a mine tailing slurry after a dispersal of a dosage amount of the product in the mine tailing slurry,
wherein the product is further adapted to reduce by 0.01% to 15% a viscosity of the mine tailing slurry after the dispersal of the dosage amount of the product in the mine tailing slurry,
wherein prior to the dispersal of the dosage amount of the product in the mine tailing slurry, the mine tailing slurry comprises solids and liquid, wherein the solids comprises mineral solid particulates.

18. The product of claim 17, wherein the dosage amount is 0.01 wt. %-3 wt. % of a dry weight of the solids of the mine tailing slurry.

19. The product of claim 17, wherein the product is adapted to increase a pump efficiency and/or a flow rate of the mine tailing slurry after dispersal of the dosage amount of the product in the mine tailing slurry.

20. The product of claim 17, wherein the dispersant includes sodium polyacrylate, tetrasodium pyrophosphate (TSPP), sodium silicate, sodium tripolyphosphate (STPP), or sodium hexametaphosphate (SHMP).

21. The product of claim 17, wherein the diatomaceous earth is flux-calcined or straight calcined.

22. The product of claim 17, wherein the product is adapted to reduce the filtration pressure of the mine tailing slurry by 0.01%-30% more than a same amount of attapulgite dispersed in the mine tailing slurry.

23. The product of claim 17, wherein the mineral solid particulates include metal particulates.

24. The product of claim 23, wherein the metal particulates include copper, gold, silver, iron, lead, zinc, uranium, nickel or rare earth elements.
